(19) United States
(12) Patent Application Publication
(10) Pub. No.: US 2024/0322147 A1
(43) Pub. Date: Sep. 26, 2024

(54) ALUMINUM ANODE, ALUMINUM ELECTROCHEMICAL CELL, AND BATTERY INCLUDING THE ALUMINUM ANODE

(71) Applicant: EaglePicher Technogies, LLC, Joplin, MO (US)

(72) Inventor: Alexander KARPINSKI, Joplin, MO (US)

(21) Appl. No.: 18/578,622

(22) PCT Filed: Jul. 14, 2022
(86) PCT No.: PCT/US2022/037120

§ 371 Date: Jan. 11, 2024

Related U.S. Application Data
(60) Provisional application No. 63/222,205, filed on Jul. 15, 2021.

(51) Int. Cl. H01M 4/46; H01M 4/02; H01M 4/04; H01M 4/62; H01M 4/90; H01M 12/08

(52) U.S. Cl. CPC H01M 4/463; H01M 4/0402; H01M 4/043; H01M 4/0471; H01M 4/621; H01M 4/9016; H01M 12/08; H01M 2004/021; H01M 2004/027; H01M 2004/028

(57) ABSTRACT

An anode for an aluminum electrochemical cell includes an aluminum alloy having a particle size of 1 micrometer to 60 micrometers, the aluminum alloy including 98 weight percent to 99.999 weight percent of aluminum and 0.001 weight percent to 2 weight percent of a dopant containing magnesium, gallium, tin, or a combination thereof, each based a total weight of the aluminum alloy, and wherein iron, copper, silicon, zinc, and nickel, if present in the aluminum alloy, is each independently contained in an amount of less than 0.001 weight percent, based on a total weight of the aluminum alloy; and wherein the anode has a porosity of 0.1% to 60%, based on a total volume of the anode.

### CROSS REFERENCE TO RELATED APPLICATION

This application claims priority to U.S. Application No. 63/222,205, filed on Jul. 15, 2021, the content of which is incorporated herein by reference in its entirety.

### BACKGROUND

This disclosure relates to an aluminum anode, an electrochemical cell including the aluminum anode, and a battery including the aluminum anode.

Aluminum-air batteries are of interest for a variety of applications, in particular for applications where long-term standby followed by high rate discharge is desirable. Nonetheless, there remains a need for improved materials for aluminum-air electrochemical cells.

### BRIEF DESCRIPTION OF THE DRAWINGS

The present invention will now be described, by way of example, with reference to the attached figures, of which:

FIG. 1 is a cross-sectional illustration of an embodiment of an aluminum-air electrochemical cell including the disclosed anode;

FIG. 2 is a cross-sectional illustration of an embodiment of an aluminum-air electrochemical cell including an anolyte comprising the disclosed aluminum alloy;

FIG. 3 is a cross-referenced sectional illustration of an embodiment of a bipolar cell;

FIG. 4 is a schematic diagram comparing a monopolar and a bipolar configuration; and

FIG. 5 shows a discharge profile of an aluminum-air electrochemical cell of the example.

### SUMMARY

An anode for an aluminum electrochemical cell is provided, wherein the anode includes: an aluminum alloy having a particle size of 1 micrometer to 50 micrometers, the aluminum alloy comprising 98 weight percent to 99.999 weight percent of aluminum and 0.0001 weight percent to 1 weight percent of a dopant comprising magnesium, gallium, tin, or a combination thereof, each based a total weight of the aluminum alloy, and wherein iron, copper, silicon, zinc, and nickel, if present in the aluminum alloy, is each independently contained in an amount of less than 0.001 weight percent, based on a total weight of the aluminum alloy; and wherein the anode has a porosity of 0.1% to 50%, based on a total volume of the anode.

In an aspect, an electrochemical cell is provided, wherein the electrochemical cell includes: the anode as described hereinabove; a cathode, and an electrolyte between the anode and the cathode.

In an aspect, a method of manufacturing an anode for an aluminum electrochemical cell is provided, the method including: contacting an aluminum alloy including aluminum and a dopant comprising magnesium, gallium, tin, or a combination thereof, and having a particle size of 1 micrometer to 60 micrometers and a liquid to form a slurry; disposing the slurry on a substrate; heat-treating the slurry to remove the liquid to form an electrode precursor; and heat-treating the electrode precursor to form an anode for an aluminum electrochemical cell.

In another method of manufacturing an anode for an aluminum electrochemical cell, the method comprises: providing a liquid comprising a binder and a liquid medium; contacting an aluminum alloy comprising aluminum and a dopant comprising magnesium, gallium, tin, or a combination thereof and having a particle size of 1 micrometer to 60 micrometers and the liquid medium to form a slurry; disposing the slurry on a substrate; heat-treating the slurry at the first temperature to remove the liquid medium and optionally the binder to form an electrode precursor; and heat-treating the electrode precursor at a second temperature to form an anode for an aluminum electrochemical cell, wherein the first temperature is less than the second temperature.

In another aspect, a method of manufacturing an anode for an aluminum electrochemical cell comprises providing an aluminum alloy comprising aluminum and a dopant comprising magnesium, gallium, tin, or a combination thereof and having a particle size of 1 micrometer to 60 micrometers; disposing the aluminum alloy on a substrate; and compacting the aluminum alloy to form the anode.

### DETAILED DESCRIPTION

Aluminum electrochemical cells produce electricity by the electrochemical coupling of a reactive aluminum alloy anode to a cathode, e.g., an air cathode, through a suitable electrolyte.

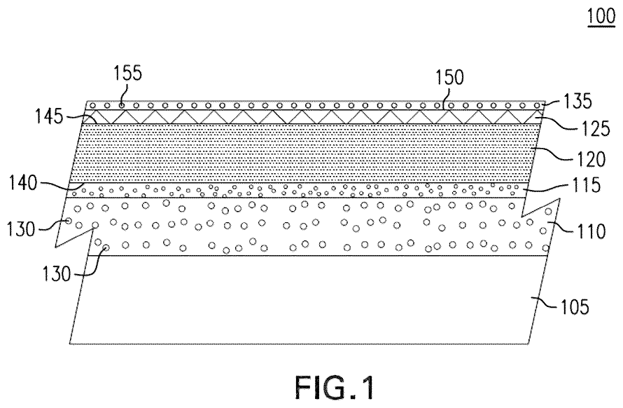

In an aspect, the aluminum electrochemical cell is an aluminum-air electrochemical cell. FIG. 1 shows a schematic illustration of an aluminum-air cell. The aluminum-air cell 100 may include an aluminum anode 105, an electrolyte 110, an air cathode 120, and a polymer membrane 135. In an aspect, an optional coating or membrane 115 may be provided between the electrolyte 110 and the air cathode 120. Also, a catalyst 125 may be provided at the air cathode 120, and certain additives 130 may be included in the electrolyte.

The aluminum electrochemical cell may be an aluminum-air cell, and may be configured to use oxygen as the cathode active material, and may be an aluminum-oxygen cell. For an aluminum-air or an aluminum-oxygen cell, the cathode is desirably permeable to a gas comprising oxygen, e.g., air, and is substantially impermeable to the aqueous electrolyte. While not wanting to be bound by theory, it is understood that in an aluminum-air or aluminum-oxygen cell, the net chemical reaction occurring is:

4Al+6H₂O+3O₂→4Al(OH)₃.

Also disclosed is an aluminum electrochemical cell wherein the oxygen is provided by an oxidizing agent, such as MnO₂, H₂O₂, silver oxide, or a combination thereof. For example, in a cell in which the oxidizing agent is silver oxide, the overall cell reaction may be written as:

Al+3/2AgO+3/2H₂O→Al(OH)₃+3/2Ag.

To date, commercially available aluminum alloy anodes have used a monolithic aluminum alloy. While not wanting to be bound by theory, it is understood that aluminum alloy particles are difficult to sinter, making manufacture of a suitable aluminum alloy anode difficult.

It has been surprisingly discovered that selected aluminum alloys can be sintered to provide an anode having suitable characteristics for use as an anode in an electrochemical cell.

In an aspect, the aluminum alloy comprises aluminum and a suitable metal in a suitable amount. The alloy may comprise, in addition to Al, Mg, Sn, Hg, Ga, In, Th, or a combination thereof. Use of an alloy comprising aluminum and tin is mentioned. Mentioned is use of an aluminum alloy comprising aluminum, tin, magnesium, gallium, or a combination thereof.

In an aspect, the aluminum alloy comprises 98 weight percent (wt %) to 99.999 wt %, 99 wt % to 99.99 wt %, or 99 wt % to 99.4 wt % aluminum, based on a total weight of the aluminum alloy.

In an aspect, the aluminum alloy comprises aluminum, and 0.001 wt % to 2 wt %, 0.01 to 1 wt %, 0.05 wt % to 0.8 wt. %, or 0.1 wt % to 0.8 wt % of a dopant comprising magnesium, tin, gallium, or a combination thereof. The content of the magnesium, if present, is 0.1 wt % to 2 wt %, 0.1 wt % to 1.5 wt %, 0.1 wt % to 1 wt %, or 0.2 to 0.8 wt %, based on a total weight of the aluminum alloy. The content of tin, if present, is 0.001 wt % to 0.5 wt %, 0.005 wt % to 0.2 wt %, or 0.01 wt % to 0.15 wt %, or 0.05 wt % to 0.1 wt %, based on a total weight of the aluminum alloy. The content of gallium, if present, is 0.0005 wt % to 0.01 wt %, 0.0005 wt % to 0.005 wt %, 0.007 wt % to 0.003 wt %, based on a total weight of the aluminum alloy.

Mentioned is an aluminum alloy comprising magnesium, tin, and gallium. A total content of the magnesium, tin, and gallium is 0.001 wt % to 2 wt %, 0.01 to 1 wt %, 0.05 wt % to 0.8 wt. %, or 0.1 wt % to 0.8 wt %, based on a total weight of the aluminum alloy. The magnesium is contained in an amount of 0.1 wt % to 1 wt % or 0.45 wt % to 0.55 wt %, the tin is contained in an amount of 0.01 wt % to 0.15 wt % or 0.06 wt % to 0.08 wt %, and the gallium is contained in an amount of 0.0005 wt % to 0.01 wt %, 0.0005 wt % to 0.005 wt %, 0.0007 wt % to 0.003 wt %, each based on a total weight of the aluminum alloy.

Some elements are avoided in the alloy, or are preferably not present. In an aspect, Fe, Cu, Si, Zn, and nickel, if present, are each independently contained in the aluminum alloy in an amount of less than 0.001 wt % (i.e., 10 ppm), less than 5 ppm or less than 1 ppm, based on a total weight of the aluminum alloy. In an aspect, a total content of any combination of Fe, Cu, Si, and Zn is less than 0.001 wt %, less than 5 ppm, or less than 1 ppm, based on a total weight of the aluminum alloy.

In an aspect, the aluminum alloy comprises particles having a particle size of 1 micrometer to 60 micrometers, 40 micrometers to 60 micrometers, 2 micrometers to 25 micrometers, 4 micrometers to 20 micrometers, or 5 micrometers to 15 micrometers. As used herein, the “particle size” refers to a particle diameter in the case of spherical particles, or a longest dimension in the case of non-spherical particles. Particle size may be determined by laser light scattering, or by scanning electron microscopy, for example.

In an aspect, the aluminum alloy anode has a specific surface area of 100 m²/g to 10,000 m²/g, 200 m²/g to 5000 m²/g, or 200 m²/g to 800 m²/g. The specific surface area can be determined by nitrogen adsorption, for example.

The aluminum alloy may comprise particles having any suitable shape. The particles may be spherical, cylindrical such as fibers, wires, or needles, or plate-like such as flakes or discs. Preferably, the particles of the aluminum alloy can have an aspect ratio of 1 to 10, or 2 to 10, or 3 to 10.

The aluminum anode may further comprise a binder. The binder may present on surface of the aluminum alloy particle. In an aspect the binder is between adjacent alloy particles.

The binder may be a thermoplastic. Examples of the thermoplastic polymers are polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, or fluorinated polymers. A combination comprising at least one of the foregoing thermoplastic polymers may be used.

The binder may comprise a thermoset. Examples of thermosetting polymers include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylic polymers, acrylate polymers, methacrylate polymers, polyalkyds, phenol-formaldehyde polymers, novolac polymers, resole polymers, melamine-formaldehyde polymers, urea-formaldehyde polymers, polyhydroxymethylfurans, polyisocyanates, diallyl phthalate polymers, triallyl cyanurate polymers, triallyl isocyanurate polymers, or unsaturated polyesterimides. A combination comprising at least one of the foregoing thermosetting polymers may be used as the binder.

In an aspect the binder may comprise a combination of the thermoplastic and the thermoset. Use of a block copolymer is mentioned.

Mentioned is use of styrene butadiene rubber (SBR), polytetrafluoroethylene, polyvinylidene fluoride, latex, polyethylene, or a combination thereof, as the binder.

A content of the binder may be contained in the aluminum anode in an amount of 0.1 wt % to 5 wt %, 0.2 wt % to 3 wt %, or 0.5 wt % to 1 wt %, based on a total weight of the aluminum anode.

The anode can have a porosity of 0.01% to 50%, 0.5% to 25%, or 1% to 10%, based on a total volume of the anode. The porosity may be determined by the Archimedes method, for example.

The cathode in the aluminum-air electrochemical cell can be a porous sheet-like member, e.g., a carbon paper, having opposite surfaces respectively exposed to the atmosphere, or to a source of oxygen, and to the aqueous electrolyte of the cell. During cell operation, oxygen is reduced within the cathode while aluminum of the anode is oxidized, providing a usable electric current flow through external circuitry connected between the anode and the cathode. The cathode desirably incorporates an electrically conductive element, e.g., a metal tab bonded to the carbon paper, to which the external circuitry can be connected.

In an aspect, the cathode 120 may include a catalytic metal layer which may be provided on a surfaces of the cathode 120. For example, the catalytic metal layer may be provided on the surface 145, or it may be provided on interstitial surfaces of the carbon matrix. Any suitable method for depositing the catalytic metal layer may be used for providing the catalytic metal layer on the cathode.

In an example, the cathode 120 may be provided with a structure 125, which may be a catalyst layer or a catalyst-coated mesh structure. The structure 125 may be a metal mesh or a polymer mesh. In some examples, the mesh may be formed of a noble metal, for example silver. In an aspect, the mesh 125 may be a metal coated nylon mesh. Any other suitable catalyst may be used to further enhance the reduction of oxygen at the cathode. In some examples, the catalyst may be coated directly onto the porous cathode 120, or it may be provided as an additional component 125, which may be attached to the cathode, for example by gluing with an oxygen permeable adhesive. In an aspect, the structure 125 may be a plurality of catalytic metal-coated particles, which are bonded to the cathode 120 using a suitable oxygen permeable adhesive. In some examples, the cathode may be formed by bonding together a plurality of carbon particles and catalytic metal-coated particles. In an aspect, the structure 125 may be provided on the opposite side of the porous cathode 120, e.g., adjacent the interior surface 140.

The electrolyte 110 may be selected as may be appropriate for the specific material used at the anode 105 in a particular application. The electrolyte may be flowing or static. In an aspect, the electrolyte 110 may be a solution of any suitable base, acid, or salt, configured to facilitate the oxidation of the anode 105. In some examples, the electrolyte 110 may be provided as a liquid (e.g., an aqueous solution), or it may be provided as a gel layer (e.g., a hydroponic gel electrolyte). In an aspect, the electrolyte 110 may include, without being limited to, electrolyte salts including potassium, sodium, calcium, aluminum, ammonium, and/or other ions. Examples of the electrolyte salts include lithium hydroxide, sodium hydroxide, potassium hydroxide, magnesium hydroxide, calcium hydroxide, ammonium chloride, aluminum trifluoromethanesulfonate, or a combination thereof. The concentration of the electrolyte salts can be 1 mole/liter (M) to 10 M, 2 M to 9 M, or 3 to 8 M in an aqueous medium such as water or a brine.

Electrolyte may comprise an additive such as an alkali metal or alkaline earth metal stannate, citrate, bicarbonate, sulfate, halide, or a combination thereof. Mentioned is use of sodium stannate, sodium phosphate, sodium citrate, sodium bicarbonate, sodium sulfate, sodium fluoride, or a combination thereof. A combination comprising at least one of the foregoing may be used. The content of the additive may be 0.0001 to 0.01 wt %, 0.0005 wt % to 0.005 wt %, based on a total weight of the electrolyte. Use of sodium stannate in an amount of 0.001 wt % to 0.01 wt %, based on a total weight of the electrolyte, is mentioned. In aspect, the electrolyte comprises seawater, and in an aspect where in the electrolyte comprises seawater, the electrolyte further comprises a citrate, such as sodium citrate. Mentioned is use of electrolyte comprising sodium chloride, e.g., seawater. Use of 0.1 wt % to 5 wt %, or 0.5 wt % to 5 wt % sodium chloride, and 0.1 wt % to 20 wt %, or 1 wt % to 10 wt % sodium citrate, based on a total weight of the electrolyte, is disclosed. Also mentioned is an electrolyte comprising 18 wt % sodium citrate and 3 wt % NaCl, based on a total weight of the electrolyte. Further mentioned is an aqueous electrolyte comprising 10 M, 2 M to 9 M, or 3 to 8 M of sodium hydroxide, potassium hydroxide, or a combination thereof, and sodium stannate in an amount of 0.001 wt % to 0.01 wt %, based on a total weight of the electrolyte.

In examples in which the anode 105 is provided in particulate form, the anode 105 may be immersed in the electrolyte 110, e.g., to form a paste. In an aspect in which the anode 105 is implemented as a porous structure, the electrolyte 110 may be disposed such that it permeates the pores of the anode 105 providing an increased surface area contact.

In aspect, use of solid or gel electrolyte maybe desirable. For example, an application may benefit from electrolyte having insignificant vapor pressure, low probability, or a very low likelihood of leaking.

The electrolyte in the battery may comprise an ionic liquid electrolyte comprising a cation having a structures such as:

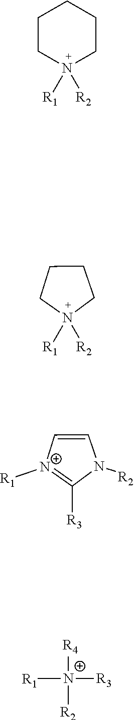

wherein R₁, R₂, R₃, and R₄ each independently comprise a non-ionizable substituent. The electrolyte may also comprises an anion comprising AlCl₄⁻, CF₃SO₃⁻, B(CO₂)₄⁻, N(SO₂CF₂CF₃)₂⁻, N(SO₂CF₃)₂⁻, N(SO₂F)₂⁻, PF₆⁻, BF₄⁻, and BF₄₋ₓ(CₙF₂ₙ₊₁)ₓ⁻, wherein x=1, 2, or 3, and n=1, 2, 3, 4, 5, 6, 7, 8, 9, or 10.

In an aspect, the electrolyte in the battery comprises an ionic constituent dissolved in an organic solvent having a high dielectric constant. In an aspect, the organic solvent is a carbonate or a sulfone, and may comprise propylene carbonate, ethylmethylsulfone, ethylmethoxyethylsulfone, methoxyethylmethylsulfone, or a combination thereof.

Also disclose is use of an electrolyte composite. The composite may comprise a polymer, a dopant, and an ion source, e.g., as disclosed in U.S. Pat. No. 10,553,901, the content which is incorporated herein by reference in its entirety.

In an aspect, the polymer is a conjugated polymer. Non-limiting examples of the polymer include polyphenylene sulfide (PPS), poly(p-phenylene oxide) (PPO), a liquid crystal polymer (e.g., a crystalline polyester), polyether ether ketone (PEEK), polyphthalamide (PPA), polypyrrole, polyaniline, or polysulfone. Also disclosed is use of a copolymer comprising a monomer of any of the foregoing polymers. A mixture may also be used. For example, a copolymer of p-hydroxybenzoic acid is mentioned. Use of polyphenylene sulfide is also mentioned.

The dopant may be an electron acceptor or oxidant. Representative electron dopants include quinones such as: 2,3-dicyano-5,6-dichlorodicyanoquinone (C₈Cl₂N₂O₂) also known as “DDQ”, tetrachloro-1,4-benzoquinone (C₆Cl₄O₂), also known as chloranil, tetracyanoethylene (C₆N₄) also known as TCNE, sulfur trioxide (“SO₃”), ozone (trioxygen or O₃), oxygen (O₂, including air), transition metal oxides including manganese dioxide (“MnO₂”), or any suitable electron acceptor, or a combinations thereof.

The ion source may comprise Li₂O, LiOH, LiNO₃, lithium bis-trifluoromethanesulfonimide (LiTFSI), lithium bis(fluorosulfonyl)imide (LiFSI), lithium bis(oxalato)borate (LiB(C₂O₄)₂“LiBOB”), lithium trifluoromethane sulfonate (lithium triflate, LiCF₃O₃S), LiPF₆ (lithium hexafluorophosphate), LiBF₄ (lithium tetrafluoroborate), LiAsF₆ (lithium hexafluoroarsenate), or a combination thereof. Hydrated forms (e.g., a monohydride) of these compounds can be used to simplify handling of the compounds. Inorganic oxides, chlorides and hydroxide are suitable ionic compounds in that they dissociate during synthesis to create at least one anionic and cationic diffusing ion. Use of Li₂O, NazO, MgO, CaO, ZnO, LiOH, KOH, NaOH, CaCl₂), AlCl₃, MgCl₂, lithium bis-trifluoromethanesulfonimide (LiTFSI), lithium bis(oxalate)borate (LiBOB), or a combination thereof, mentioned.

In an aspect, a separation membrane 115 may be provided between the electrolyte/anode assembly and the cathode. The membrane 115 may be selected to be suitable for gas and ion exchange. Also, if movement of the electrolyte, e.g., in a flowing electrolyte cell, is desired, a screen, e.g. a mesh, can be used. The screen may comprise polyethylene, nylon, polyester, polytetrafluoroethylene, or recombination thereof. An example of a commercially available polyethylene screen is VEXAR. In an aspect, the membrane 115 may be a porous membrane and have suitable porosity, e.g., to prevent electrolyte from evaporating. In an aspect, to provide the anode with structural support, the optional membrane 115 may be provided to enclose and/or contain the anode/electrolyte assembly. As will be appreciated, membrane 115, if used, may be selectively tailored to offer the desired permeability, e.g., gas/liquid and/or ion exchange as desired, and the desirable structural functionality to provide a desired shape of the cell. Thus, in an aspect, a membrane 115 suitable for gas and ion exchange may be provided between the electrolyte/anode assembly and the air cathode.

The electrochemical cells may include a polymer membrane 135, which may be a selectively permeable membrane and may be disposed an outer surface of the anode-cathode assembly. In an aspect, the membrane 135 may be provided along an outer surface 150 of the electrochemical cell 100. In an aspect, the surface 145 may be the outer surface of the electrochemical cell. In an aspect, the membrane 135 may extend around some or all of the perimeter of electrochemical cell 100. As can be appreciated, a double-sided configuration may be implemented, where a central anode is immersed and/or surrounded by an electrolyte and air cathode.

In an aspect, the membrane 135 may be a gas-permeable membrane. For example, it may allow oxygen, or other gases, to pass through the membrane 135, while preventing liquids, such as water, from penetrating the membrane 135. In some examples, the membrane may be porous, and the pore size may be based, in part, on the molecular size of molecules desired to be blocked or pass through the membrane. In some examples, the permeability of the membrane 135 may be tailored to allow certain molecules to penetrate the membrane while certain other molecules are to be prevented from penetrating the membrane. In some examples, the membrane 135 may be coated with or include a hydrophobic material. In some examples, the membrane 135 may be formed from a polymer, such as ethylene for example.

As can be appreciated, the membrane 135 may be selected to have a thickness as may be suited for the particular application. The membrane 135 may comprise an oxygen-permeable microporous polyethylene membrane. The oxygen-permeable membrane may be disposed between the ambient air and the air cathode 120 to facilitate gas exchange at the cathode 120.

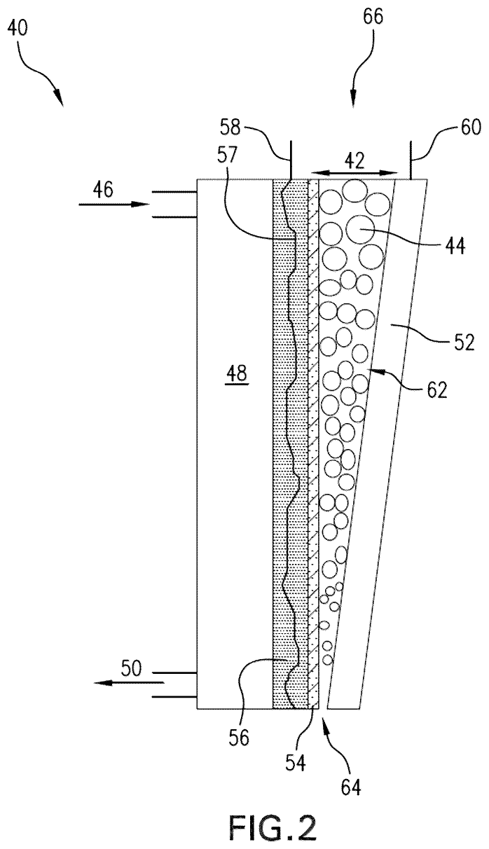

In aspect, the electrical electrochemical cell may comprise a flowing configuration, e.g., as disclosed in U.S. Pat. No. 5,434,020, the content of which is incorporated herein by reference in its entirety. The cell having a flowing configuration shown in FIG. 2. A tapered electrochemical cell 40, with a varying gap (or cell width) dimension 42. Electrochemically active particles of the aluminum alloy 44 are contained between an anode current collector 52 and a porous, electrically insulating separator 54, which is connected to a gaseous diffusion cathode, such as an air cathode 56 with an internal current collector 57. A gas comprising oxygen, e.g., air, flows through an intake port 46, through an air flow chamber 48 situated next to the air cathode 56, and out of an air exit port 50. A positive current lead 58 and a negative current lead 60 are connected to the cathode current collector 57 and anode current collector 52, respectively. The particle bed 62 is permeated with an electrolyte solution, which typically enters the narrow end 64 of the cell 40 and exits the wider end 66. The reverse flow is also possible.

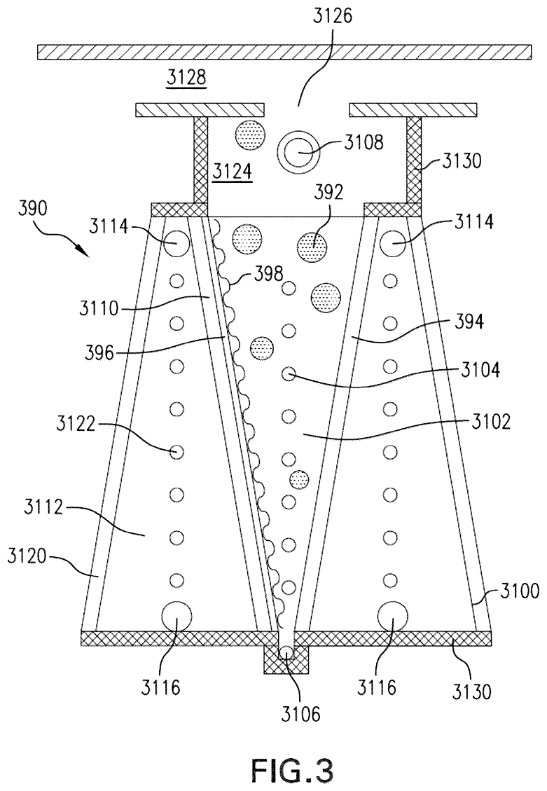

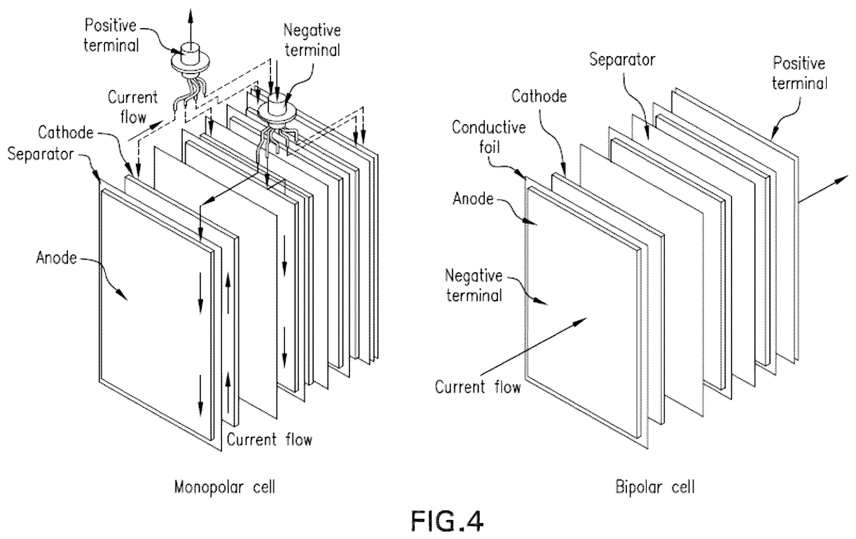

The cell may have a monopolar or bipolar configuration, and may have a static or flowing anolyte, and/or a static or flowing catholyte. Shown in FIG. 3 is a cell having a bipolar flowing analyte. A monopolar configuration is also mentioned, and could be provided by one of skill in the art without undue experimentation. Monopolar and bipolar configurations are shown in FIG. 4.

As shown in FIG. 3, the cell 390 is configured for bipolar electrical series connection and has a tapered or wedge-shaped unifunctional cells that can be connected in parallel or in series. In a bipolar cell, the current flow is substantially perpendicular to the electrode throughout the cell. Current passes through the body of the cell to adjacent cells connected in electrical series, without the use of external leads or buses. For purposes of clarity, the dimensions of FIG. 3 (particularly the included angle between elements 96 and 94) are greatly exaggerated.

The anode material comprises the disclosed aluminum alloy particle. The aluminum particle may be in an alkaline or halide solution or suspension.

The particles 392 are contained between an electrically conductive transfer plate 394, such as a sheet of copper electroplated with nickel, and an electronically nonconductive, porous interelectrode separator 396, such as a wettable membrane (e.g., polymer fabric). Use of a polyethylene mesh, e.g., VEXAR, is mentioned. An anode current collector 398, such as a metal screen (e.g., nickel-plated copper screen or expanded perforated metal sheet), rests against the separator 396 and makes electrical contact with the particles 392.

The anode current collector 398 may be spot welded or soldered to vertical metallic or metallized plastic ribs 3100. The ribs 3100 define the anode chamber 3102 dimensions and provide an electronically conductive path of low resistance between the anode current collector 398 and the conductive transfer plate 394. The ribs 3100 are a series of perforated, lengthwise plates with holes 3104 through which electrolyte may flow. Other functional designs of the ribs 3100 are possible, including screens or nonperforated ribs. Line contact ribs can be supplemented with a peripheral conductive frame at the edges of the air electrode, which may be soldered to a metallic current collector internal to the air electrode.

The electrolyte enters the cell 390 through an electrolyte intake manifold 3106, diffuses through the cell cavity or anode chamber 3102 containing the bed of particles 392, and exits through an electrolyte exhaust port 3108. The electrolyte flow may be from bottom to top as shown, or alternatively from top to bottom.

The other side of the separator 396 rests against a gas diffusion electrode 3110, such as an air electrode with an internal current collector (not shown). The air electrode 3110 forms a surface of an oxidant chamber, e.g., air-flow chamber 3112, that is provided to allow circulation of air on the dry side of the oxidant, e.g., air, electrode 3110. The air enters through an air intake port 3114, circulates through the chamber 3112, and exits through an air outlet port 3116. The air electrode 3110 is supported on a gridwork of electrically conductive ribs 3118, which connect the air electrode 3110 with a conductive transfer plate 3120.

Electrical contact between the ribs 3118 and the dry conductive side of the air electrode 3110 is maintained by compressive forces between the ribs 3118 and the air electrode 3110, resulting from the mass of the particle bed. Again, the ribs 3118 are a series of perforated, lengthwise plates with holes 3122 that serve as gas passageways. The air electrode 3110 current passes through the conductive gridwork to the transfer plate 3120, and through the transfer plate 3120 to an adjacent anode chamber (not shown) bounded by this transfer plate. The included angle between the broad surfaces (i.e., air electrode 3110 and transfer plate 94, 120) is preferably in the range of about 0.1°-3°.

FIG. 3 shows the electrochemical cell 390 having an overlying portion which serves as a hopper or reservoir 3124 of unconsumed particles 392, which are continuously fed by gravity into the anode chamber 3102. The reservoir 3124 portion of the cell 390 is increased in width to accommodate a larger fraction of the particles 392, and has a width which is preferably larger than five (5) times the diameter of the feed particles 392 to prevent bridging and allow the free flow of particles 392 into the cell 390. A slurry of particles 392 and the electrolyte are transferred through an opening 3126 into the reservoir 3124 from a tube or conduit 3128, which allows a high-rate transfer of the slurried mixture during mechanical refueling operation. This duct 3128 is empty during discharge. The cell 390 is contained in non-conductive housing 3130, which is preferably formed of a polymer (e.g., injected molded polypropylene, chlorinated polyvinyl chloride, or epoxy resin filled with hollow glass spheres).

Also mentioned is a configuration in which the catholyte is flowing. The details of a flowing catholyte configuration can be analogous to the flowing anolyte configuration disclosed above, and can be determined by one of skill in the art without undue experimentation.

A method of manufacturing the aluminum anode is also disclosed.

In aspect, particles of the aluminum alloy particles may be bonded together using a binder. A method of manufacturing an anode for an aluminum electrochemical cell may comprise providing a liquid comprising a binder and a liquid medium; contacting an aluminum alloy comprising aluminum and a dopant comprising magnesium, gallium, tin, or a combination thereof and having a particle size of 1 micrometer to 50 micrometers and the liquid to form a slurry; disposing the slurry on a substrate; heat-treating the slurry to remove the liquid medium to form an electrode precursor; and heat-treating the electrode precursor to form an anode for an aluminum electrochemical cell. A temperature suitable to remove the liquid may be 10° C. to 200° C., or 20° C. to 100° C. Also, the heat-treating of the electrode precursor may comprise heat-treating at 100° C. to 500° C., or 200° C. to 400° C.

The liquid medium may comprise water. In aspects, the liquid medium may comprise any suitable organic solvent, e.g., a carbonate such as propylene carbonate, or N-methyl-2-pyrrolidone (NMP). Combination of water and organic solvents can be used.

In an aspect, the anode may be formed by compacting the aluminum alloy particles to form the anode. A method of manufacturing the anode may comprise: providing an aluminum alloy comprising aluminum and a dopant comprising magnesium, gallium, tin, or a combination thereof and having a particle size of 1 micrometer to 50 micrometers; disposing the aluminum alloy on a substrate; compacting the aluminum alloy to form the anode. The compacting may comprise compacting at a pressure suitable to bond the particles together, e.g., a pressure of 1 megaPascal to 1 gigaPascal.

In an aspect, the combination of temperature and pressure may be used. In aspect, the particles may be pressed in the heat press at a suitable temperature, e.g., 500° C. to 1300° C., 600° C. to 1200° C., or 700° C. to 1100° C., at a suitable pressure, e.g., 1 megapascal to 1 gigapascal.

In an aspect, disclosed is a method of manufacturing an anode for an aluminum electrochemical cell, the method comprising: providing the liquid comprising a binder and a liquid medium; contacting the aluminum alloy comprising aluminum and a dopant comprising magnesium, gallium, tin, or a combination thereof and having a particle size of 1 micrometer to 50 micrometers and the liquid to form a slurry; disposing the slurry on a substrate; heat-treating the slurry to remove the liquid medium to form an electrode precursor; and heat-treating the electrode precursor at e.g., 500° C. to 1300° C., 600° C. to 1200° C., or 700° C. to 1100° C. to form an anode for an aluminum electrochemical cell.

### Example

An aluminum alloy comprising aluminum, 0.07 wt % tin, 0.5 wt % magnesium, and 0.001 wt % gallium, and having a total content of iron, copper, silicon, zinc, and nickel of less than 0.00001 wt %, was provided in the form of particles having a particle size of 40 micrometers to 60 micrometers, as determined by light scattering. The aluminum alloy was combined with a binder and the resultant was disposed on a heated substrate, and compressed at 50 megapascals at a temperature of 500° C. for 30 minutes to provide an anode. The anode had a porosity of 40% to 60%, based on a total volume of the anode, as determined by the Archimedes method.

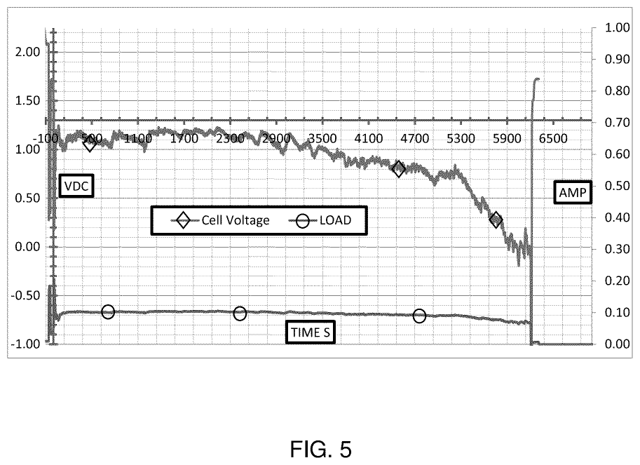

The anode was discharged in an aluminum-air electrochemical cell having an alkaline electrolyte comprising 45 wt % KOH and sodium stannate and a silver oxide cathode. The results are shown in FIG. 5.

Disclosed is an anode for an aluminum electrochemical cell, the anode comprising: an aluminum alloy having a particle size of 1 micrometer to 60 micrometers, the aluminum alloy comprising 98 weight percent to 99.999 weight percent of aluminum and 0.001 weight percent to 2 weight percent of a dopant comprising magnesium, gallium, tin, or a combination thereof, each based a total weight of the aluminum alloy, and wherein iron, copper, silicon, zinc, and nickel, if present in the aluminum alloy, is each independently contained in an amount of less than 0.001 weight percent, based on a total weight of the aluminum alloy; and wherein the anode has a porosity of 0.1% to 60%, based on a total volume of the anode.

Disclosed is an electrochemical cell comprising: the anode; a cathode; and an electrolyte between the anode and the cathode.

Disclosed is an aluminum battery comprising a plurality of the cells.

Disclosed is a method of manufacturing an anode for an aluminum electrochemical cell, the method comprising: providing a liquid comprising a binder and a liquid medium; contacting an aluminum alloy comprising aluminum and a dopant comprising magnesium, gallium, tin, or a combination thereof and having a particle size of 1 micrometer to 60 micrometers and the liquid comprising the binder and the liquid medium to form a slurry; disposing the slurry on a substrate; heat-treating the slurry to remove the liquid medium to form an electrode precursor; and heat-treating the electrode precursor to form an anode for an aluminum electrochemical cell.

Disclosed is a method of manufacturing an anode for an aluminum electrochemical cell, the method comprising: providing a liquid comprising a binder and a liquid medium; contacting an aluminum alloy comprising aluminum and a dopant comprising magnesium, gallium, tin, or a combination thereof and having a particle size of 1 micrometer to 60 micrometers and the liquid to form a slurry; disposing the slurry on a substrate; heat-treating the slurry at a first temperature to remove the liquid medium and optionally the binder to form an electrode precursor; and heat-treating the electrode precursor at a second temperature to form an anode for an aluminum electrochemical cell wherein the first temperature is less than the second temperature.

Disclosed is a method of manufacturing an anode for an aluminum electrochemical cell, the method comprising: providing an aluminum alloy comprising aluminum and a dopant comprising magnesium, gallium, tin, or a combination thereof and having a particle size of 1 micrometer to 60 micrometers; disposing the aluminum alloy on a substrate; compacting the aluminum alloy to form the anode.

In any of the foregoing embodiments, the binder may be present in an amount of 0.1 weight percent to 5 weight percent, based on a total weight of the anode; the anode has a specific surface area of 200 m²/g to 800 m²/g; the electrolyte may comprise lithium hydroxide, sodium hydroxide, potassium hydroxide, magnesium hydroxide, calcium hydroxide, or a combination thereof and optionally the electrolyte may further comprise sodium stannate, a sodium citrate, or a combination thereof; the cathode may be configured for contact with air; the cathode may be configured for contact with oxygen; the cathode may be configured for contact with hydrogen peroxide; the cells may have a bipolar configuration; the cathode may comprises a metal oxide; the metal oxide may comprise silver oxide, zinc oxide, lead oxide, cadmium oxide, or a combination thereof; the metal oxide may have a particle size of 0.1 micrometer to 10 micrometers; the metal oxide may comprise silver oxide having a particle size of 1 micrometer to 10 micrometers; and the compacting may comprise hot-pressing at a temperature of 500° C. to 1200° C. at 1 megapascal to 1 gigapascal.

What is claimed is:

1. An anode for an aluminum electrochemical cell, the anode comprising:
an aluminum alloy having a particle size of 1 micrometer to 60 micrometers, the aluminum alloy comprising 98 weight percent to 99.999 weight percent of aluminum and 0.001 weight percent to 2 weight percent of a dopant comprising magnesium, gallium, tin, or a combination thereof, each based a total weight of the aluminum alloy, and wherein iron, copper, silicon, zinc, and nickel, if present in the aluminum alloy, is each independently contained in an amount of less than 0.001 weight percent, based on a total weight of the aluminum alloy; and
wherein the anode has a porosity of 0.1% to 60%, based on a total volume of the anode.

2. The anode of claim 1, wherein the aluminum alloy comprises 0.1 to 1 weight percent of magnesium, and 0.01 to 0.15 weight of tin, each based on a total weight of the aluminum alloy.

3. The anode of claim 2, wherein the aluminum alloy further comprises 0.0005 to 0.01 weight percent of gallium.

4. The anode of claim 1, wherein the aluminum alloy comprises particles with an aspect ratio of 1 to 10.

5. The anode of claim 1, wherein the aluminum alloy has a particle size of 20 to 60 microns, and the anode has a porosity of 40 to 60%, based on a total volume of the anode.

6. The anode of claim 1, further comprising a binder, and wherein the binder is present in an amount of 0.1 weight percent to 5 weight percent, based on a total weight of the anode.

7. The anode of claim 1, wherein the anode has a specific surface area of 200 m²/g to 800 m²/g.

8. An electrochemical cell comprising:
the anode of claim 1;
a cathode; and
an electrolyte between the anode and the cathode.

9. The electrochemical cell of claim 8, wherein the electrolyte comprises lithium hydroxide, sodium hydroxide, potassium hydroxide, magnesium hydroxide, calcium hydroxide, ammonium chloride, aluminum trifluoromethanesulfonate, or a combination thereof.

10. The electrochemical cell of claim 9, wherein the electrolyte further comprises sodium stannate, sodium citrate, or a combination thereof.

11. The electrochemical cell of claim 8, wherein the cathode is configured for contact with air.

12. The electrochemical cell of claim 8, wherein the cathode is configured for contact with oxygen.

13. The electrochemical cell of claim 8, wherein the cathode is configured for contact with hydrogen peroxide.

14. The electrochemical cell of claim 8, wherein the cathode comprises a metal oxide.

15. The electrochemical cell of claim 14, wherein the metal oxide comprises silver oxide having a particle size of 1 micrometer to 10 micrometers.

16. An aluminum battery comprising a plurality of the cells of claim 8.

17. The battery of claim 16, wherein the cells have a bipolar configuration.

18. A method of manufacturing an anode for an aluminum electrochemical cell, the method comprising:
providing a liquid comprising a binder and a liquid medium;
contacting an aluminum alloy comprising aluminum and a dopant comprising magnesium, gallium, tin, or a combination thereof and having a particle size of 1 micrometer to 60 micrometers and the liquid to form a slurry;
disposing the slurry on a substrate;
heat-treating the slurry to remove the liquid medium to form an electrode precursor; and
heat-treating the electrode precursor to form an anode for an aluminum electrochemical cell.

19. A method of manufacturing an anode for an aluminum electrochemical cell, the method comprising:
providing a liquid comprising a binder and a liquid medium;
contacting an aluminum alloy comprising aluminum and a dopant comprising magnesium, gallium, tin, or a combination thereof and having a particle size of 1 micrometer to 60 micrometers and the liquid to form a slurry;
disposing the slurry on a substrate;
heat-treating the slurry at the first temperature to remove the liquid medium to form an electrode precursor; and
heat-treating the electrode precursor at a second temperature to form an anode for an aluminum electrochemical cell,
wherein the first temperature is less than the second temperature.

20. A method of manufacturing an anode for an aluminum electrochemical cell, the method comprising:
providing an aluminum alloy comprising aluminum and a dopant comprising magnesium, gallium, tin, or a combination thereof and having a particle size of 1 micrometer to 60 micrometers; and
disposing the aluminum alloy on a substrate;
compacting the aluminum alloy to form the anode.

21. The method of claim 20, where the compacting comprises hot-pressing at a temperature of 500° C. to 1200° C. at 1 megapascal to 1 gigapascal.
